(19) United States
(12) Patent Application Publication
(10) Pub. No.: US 2006/0050651 A1
(43) Pub. Date: Mar. 9, 2006

(54) Establishing a coordinate system and coordinates for nodes in a network

(76) Inventors: Cyril Brignone, Mountain View, CA (US); Salil Pradhan, San Jose, CA (US); Tim Connors, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/922,627

(22) Filed: Aug. 19, 2004

(51) Int. Cl. H04L 12/28

(52) U.S. Cl. 370/254

(57) ABSTRACT

A method of determining coordinates for nodes in a network. In response to a node being selected, the node broadcasts a request to other nodes for respective coordinate information of the other nodes. Based on the response to the request, the node takes one of the following steps. The node establishes itself as an origin of the coordinate system if no nodes respond to the request with coordinates. The node establishes a first axis of the coordinate system if one node responds to the request with coordinates. The node establishes a second axis of the coordinate system if two nodes respond to the request with coordinates. And, the node determines coordinates for the node based on distance measurements to selected nodes having established coordinates if three nodes respond to the request with coordinates.

### TECHNICAL FIELD

Embodiments of the present invention relate to the field of networked electronic devices. Specifically, embodiments of the present invention relate to establishing a common coordinate system and coordinates for nodes in a network of electronic devices.

### BACKGROUND ART

It is becoming increasingly useful to establish a network of electronic devices that know their respective coordinates in a common coordinate system. For example, the network of electronic devices can be used to assist navigation through a building. Assume a person desires to locate a printer in a building. The user can locate the printer by navigating through the building with a hand-held device that displays a map of the building with the user's current position highlighted.

To assist in the navigation, a network of electronic devices can be placed throughout the building with each device's coordinates being known by the device and/or a back-end system. A map of the building with coordinates is developed, such that portions of the map can be displayed on a hand-held electronic device if the coordinates of the hand-held device are known. As a person holding the electronic device navigates through the building, the hand-held electronic device communicates with the other electronic devices to obtain its coordinates, such that the user's position in the building is displayed on the electronic device.

For the above and other purposes, it is useful for each electronic device to know its coordinates in the building. The well-known global positioning system (GPS) is not well suited for use inside of a building because GPS relies on receiving a satellite signal, which tends to be weak inside of buildings. Therefore, another means must be used to establish the coordinates of the various electronic devices in the building. One technique of establishing these coordinates is for a person to physically take measurements to determine a device's coordinates, which is then programmed into the electronic device and/or a back-end server. This technique is not only tedious but is error prone. Moreover, if the position of the electronic device is altered, its coordinates must be updated. For example, one of the electronic devices could be a computer system, printer, etc., which is free to be moved.

Other techniques for establishing coordinates for electronic devices in a building are not suitable for devices with limited computing power because the techniques are computationally intensive. For example, devices such as cell-phones have limited computational power, but it is very desirable to use such devices as navigation tools because they are so ubiquitous.

Thus, some techniques for establishing a coordinate system for a network of electronic devices require tedious and error prone manual steps to establish coordinates for each electronic device. Another problem with various techniques for establishing a coordinate system for a network of electronic devices is that the intense computing power required is not suitable for electronic devices with limited computing power.

### DISCLOSURE OF THE INVENTION

Embodiments of the present invention pertain to establishing a coordinate system and coordinates for nodes in a network. One embodiment of the present invention is a method of establishing a coordinate system for a network of nodes. This embodiment includes establishing an origin of the coordinate system by receiving an indication that a first node is selected, and in response to the indication that the first node is selected, automatically determining that the first node is the origin of the coordinate system. A first axis is established for the coordinate system by receiving an indication that a second node is selected, and in response to the indication that the second node is selected, automatically determining the first axis based on a line between the first node and the second node. In other embodiments, the coordinate system is extended to a second and a third axis, respectively.

Another embodiment of the present invention is a method of propagating an established coordinate system to additional nodes. The method comprises a new node that does not yet have coordinates determining a first pair of possible coordinates for that new node, based on first distance measurements between the new node and first nodes having first respective node coordinates. One set of coordinates of the pair is a valid set of coordinates and the other are invalid. The new node determines a second pair of possible coordinates for the new node, based on second distance measurements between the new node and second nodes having second respective node coordinates. The second distance measurements comprise at least one measurement to a node not in the first nodes. For example, in an embodiment using a two-dimensional coordinate system, the new node may access distance measurements to two nodes, wherein at least one node was not used to determine the first pair of possible coordinates. The new node determines defined coordinates for the new node by determining one set of coordinates from each of the first and second pair of possible coordinates as valid coordinates and basing the defined coordinates on the determined valid coordinates.

Yet another embodiment of the present invention is a method of determining coordinates for nodes in a network. In accordance with this method, in response to a node being selected, the node broadcasts a request to other nodes for respective coordinate information of the other nodes. Based on the response to the request, the node takes one of the following steps. The node establishes itself as an origin of the coordinate system if no nodes respond to the request with coordinates. The node establishes a first axis of the coordinate system if one node responds to the request with coordinates. The node establishes a second axis of the coordinate system if two nodes respond to the request with respective coordinates. And, the node determines coordinates for the node based on distance measurements to selected nodes having established coordinates if three nodes respond to the request with respective coordinates.

Embodiments of the present invention are suited for one-, two-, and three-dimensional coordinate systems.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram illustrating a building with numerous nodes for which embodiments of the present invention establish a common coordinate system.

FIG. 2 illustrates an exemplary node that may serve as a platform upon which to perform embodiments of the present invention.

FIGS. 3A-3D are diagrams illustrating a user establishing a coordinate system by selecting nodes, in accordance with an embodiment of the present invention.

FIG. 4 is a flowchart illustrating steps of a process of establishing a coordinate system for a network of nodes, in accordance with an embodiment of the present invention.

FIG. 5A is a diagram illustrating a node determining two possible coordinates for itself, in accordance with an embodiment of the present invention.

FIGS. 5B and 5C are diagrams illustrating a node determining which coordinates of pairs of potential coordinates are valid, in accordance with an embodiment of the present invention.

FIG. 6 is a flowchart illustrating a process of selecting nodes to use for propagating a coordinate system to a new node, in accordance with an embodiment of the present invention.

FIG. 7 is a flowchart illustrating steps of a process of propagating a coordinate system for a network of nodes, in accordance with an embodiment of the present invention.

### DETAILED DESCRIPTION OF THE INVENTION

In the following detailed description of embodiments of the present invention, establishing a coordinate system and coordinates for nodes in a network, numerous specific details are set forth in order to provide a thorough understanding of the present invention. However, embodiments of the present invention may be practiced without these specific details or by using alternative elements or methods. In other instances, well known methods, procedures, components, and circuits have not been described in detail as not to unnecessarily obscure aspects of the present invention.

### Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “establishing” or “processing” or “computing” or “basing” or “calculating” or “determining” or “selecting” or “rejecting” or “recognizing” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Establishing and Propagating a Coordinate System

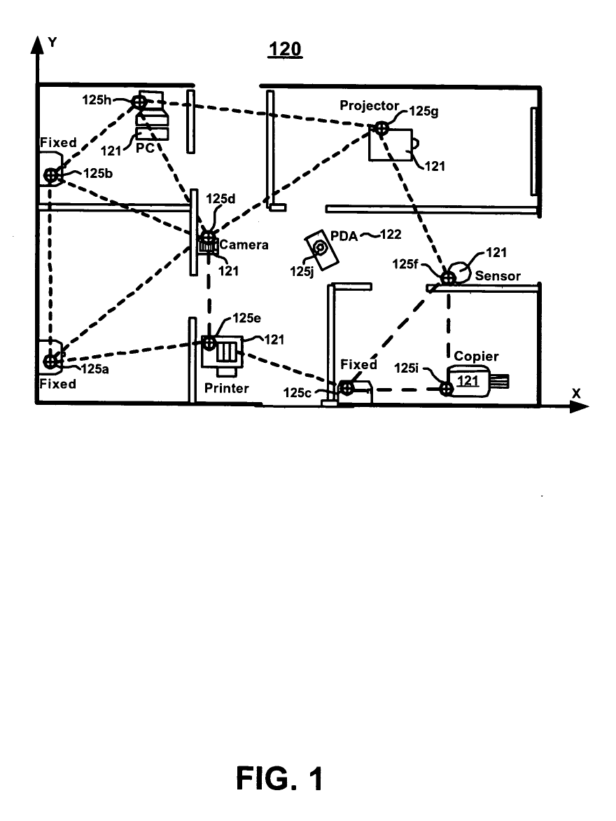

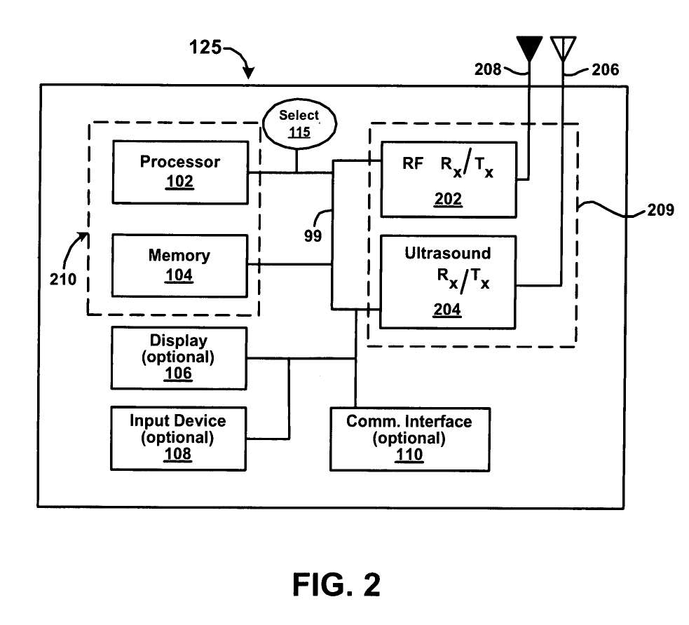

FIG. 1 illustrates an exemplary environment 120 having various nodes 125a-j each with their own coordinates in a common coordinate system that embodiments of the present invention develop. The nodes 125a-j comprise electronic components that may be attached to or placed near various devices 121 such as, for example, personal computers, projectors, etc. Alternatively, the node 125 may be integrated into the various devices 121 depicted in FIG. 1. An exemplary node 125 is depicted in FIG. 2.

An embodiment of the present invention establishes the coordinate system shown in FIG. 1 (i.e., the x-y coordinate system) with minimal user intervention by selecting a few of the nodes 125, which automatically determine the axes of the coordinate system. Another embodiment propagates the coordinate system to additional nodes. The coordinate system in FIG. 1 comprises an x-axis and a y-axis. A z-axis may also be added. Also, some application may only require a single axis. The nodes 125 are able to communicate with one another to develop a common coordinate system and coordinates for each node, in accordance with embodiments of the present invention. The communication involves requests of other nodes for known coordinates and distance measurements between nodes to help establish the coordinate system and coordinates for nodes.

The nodes 125a-j may be classified as infrastructure nodes and mobile nodes. An infrastructure node tends to remain in the same location for substantial periods of time, although an infrastructure node can be moved. As their name suggests, a mobile node tends to be mobile. Exemplary mobile nodes are personal digital assistants (PDAs), cell-phones, etc. In FIG. 1 node 125j, which is associated with the PDA 122, is a mobile node. In one embodiment, infrastructure nodes assist other nodes in determining their location, and themselves obtain their coordinates (or coordinate if using a one-dimensional coordinate system) based on communication with other infrastructure nodes. In one embodiment, a mobile node obtains its location (or coordinates) from infrastructure nodes, but does not help other nodes to determine their location. For a short period of time after being moved, an infrastructure node may be classified as a mobile node.

In the example in FIG. 1, all of the nodes (125a-i) except node 125j associated with the PDA 122 are classified as infrastructure nodes, at least while they are stationary. Some of the infrastructure nodes are fixed nodes (125a-c), whose primary purpose is to provide an additional node 125 for other nodes 125 to communicate with. The fixed nodes 125a-c are stand-alone nodes in that they are not associated with a device 121 such as a printer, PC, etc. Some of the nodes (125d-i) are associated with ordinary devices 121, such as personal computers, printers, copiers, projectors, sensors, and cameras. The various nodes 125a-i in FIG. 1 may implement many applications, including environmental monitoring, asset monitoring, building security, systems control, and in-building navigation.

Embodiments of the present invention are well suited to indoor networks, where the global positioning system (GPS) is not well suited because the satellite signal that GPS uses tends to be weak in indoor environments. However, the present invention is not limited to indoor networks. Embodiments of the present invention are well suited to determining coordinates for the various nodes, while requiring very little user intervention. Moreover, embodiments of the present invention do not require tedious and error prone user measurements. Furthermore, embodiments of the present invention do not require substantial computing power or complexity. For example, some embodiments use only a mathematical square root (and square) function, in addition to basic mathematical operations of addition, subtraction, multiplication, and division. Thus, embodiments of the present invention may be implemented on devices that allow for only simple mathematical functions. Further, even if devices allow for more complex mathematical functions, embodiments of the present invention save computational time when determining a node's coordinates, in comparison to more complex techniques.

FIG. 2 illustrates an exemplary node 125, in accordance with an embodiment of the present invention. The exemplary node 125 has a radio frequency (RF) receiver/transmitter 202 with RF antenna 208 and an ultrasound receiver/transmitter 204 with antenna 206, which together form a communication unit 209. In one embodiment, to determine a distance between two nodes, a first node simultaneously transmits an RF signal and an ultrasound signal. The second node notes the time difference between the reception of the RF signal and the ultrasound signal to determine the distance between the nodes. However, it is not required that the RF and ultrasound signals be transmitted simultaneously. Moreover, the distance between nodes may be determined in any convenient fashion, and thus the distance measuring technique is not limited to using an RF and/or an ultrasound signal.

The exemplary node 125 also has a processing unit 210 comprising a processor 102 and computer readable memory 104 coupled to a bus 99. Embodiments of the present invention store network information, such as coordinates of this node and other nodes in the network. Moreover, software instructions are stored on the computer readable medium 104, which when executed on the processor 102 implement embodiments in accordance with the present invention. The node 125 has an optional display, which may be used to depict a map of a building with a marker of the node's current coordinates. The node 125 may also have an optional input device 108, such as, for example, a keypad. The node 125 may also optionally have a communication interface 110, such as, for example, a serial data interface or a parallel data interface

The exemplary node 125 also has a select button 115, which may be used to notify the node 125 that it has been selected to join the network, as will be described more fully herein. It will be understood that a node may be selected in any convenient fashion. The various electronic components depicted in the exemplary node 125 may be attached to or placed near various devices, such as the devices 121 depicted in FIG. 1. Alternatively, the various electronic components of a node 125 may be integrated into such devices 121.

In accordance with one embodiment of the present invention, a coordinate system is established with minimal user-intervention. In this embodiment, a node responds to being selected by establishing itself as the origin of the coordinate system. Then, the x-axis is established by a second node responding to being selected, wherein the x-axis is established as a line between the first and second node. Next, the y-axis is established by a third node responding to being selected, as described below. In this embodiment, the coordinate system is two-dimensional; however, embodiments of the present invention are well suited to one- or three-dimensional coordinate systems.

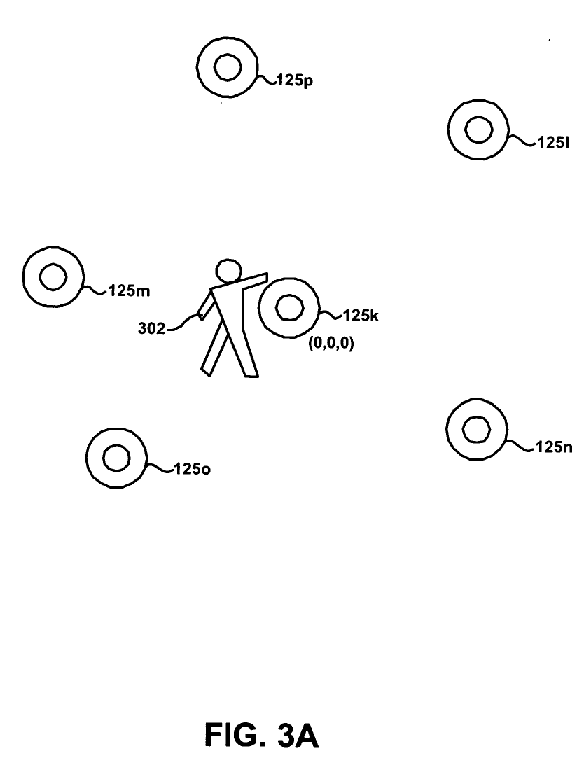

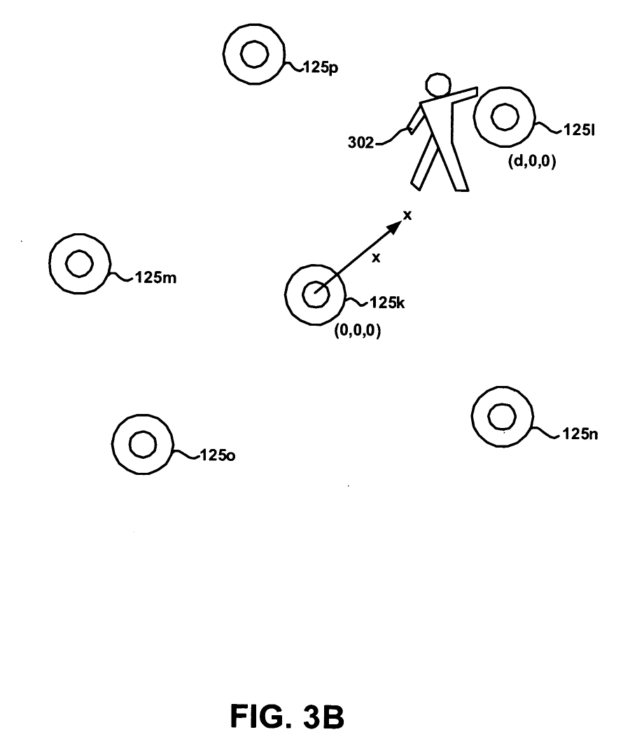

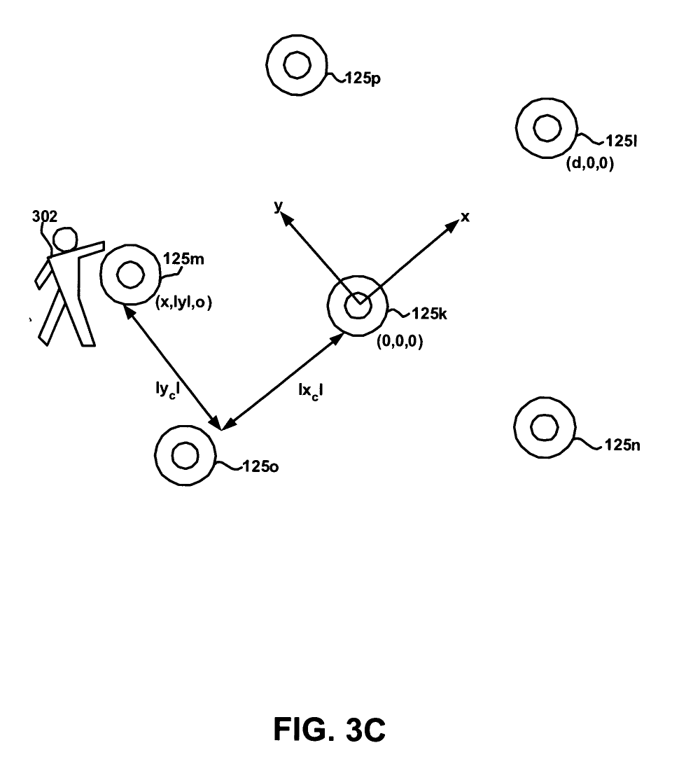

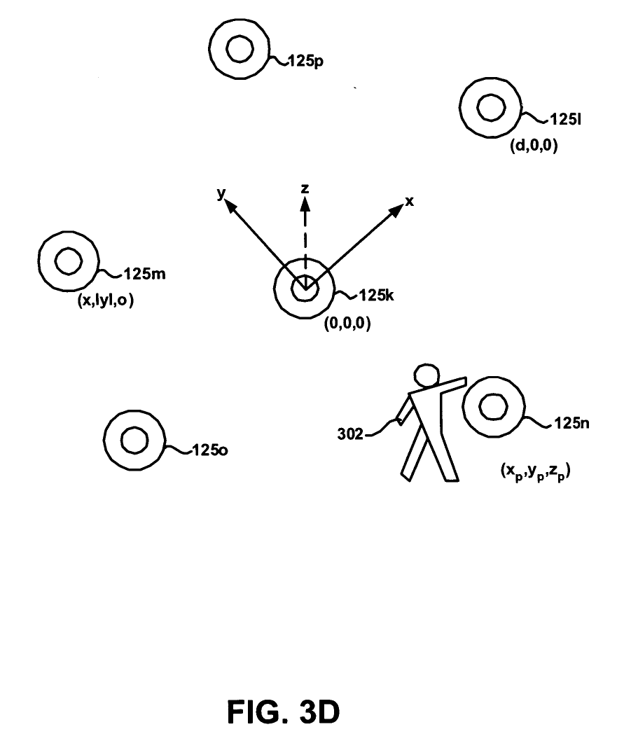

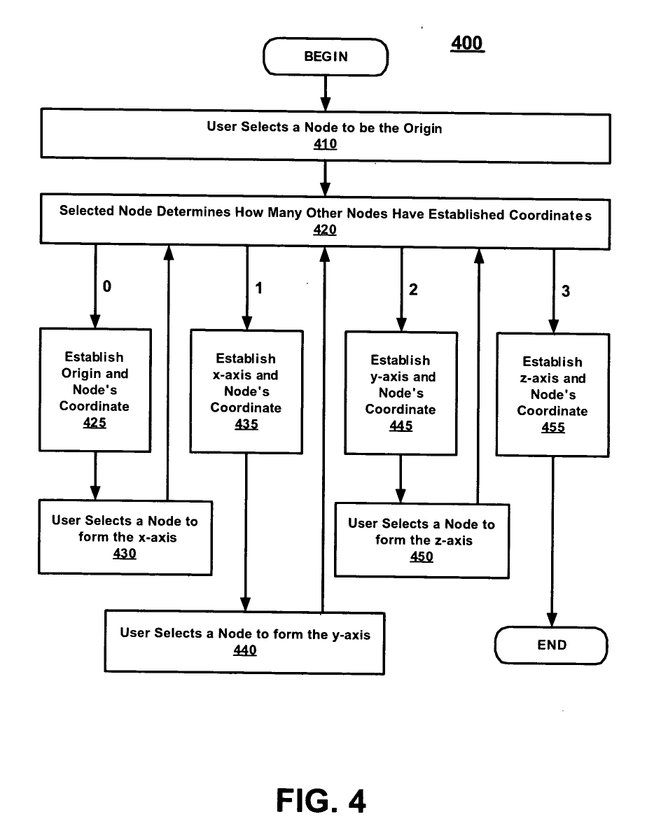

FIGS. 3A-3D illustrate establishing a coordinate system having three-axes by four nodes responding to being selected, in accordance with an embodiment of the present invention. FIG. 4 depicts a flowchart illustrating steps of this embodiment. Some of the steps of process 400 in FIG. 4 are implemented by storing instructions in a computer readable medium, which are executed on a processor. However, not all of the steps of process 400 are so implemented. Referring to step 410 in FIG. 4 and to FIG. 3A, a user 302 selects one of the nodes 125k to be to origin of the coordinate system. The user 302 is free to select any convenient node 125. The selection may be achieved by any convenient technique, such as, for example, the user 302 touching a select button (FIG. 2, 115) on the node 125k. In one embodiment, the selection occurs by having the user power on the node 125.

Referring to step 420 of FIG. 4, upon being selected, the first node 125k broadcasts requests for other nodes 125l-p to respond with their coordinates. It will be understood that node 125k may have no knowledge of the other nodes 125l-p. Because node 125k is the first node selected, no other node (e.g., 125l-p) will respond with their coordinates. The first node 125k interprets this as an indication that it is the first node to establish coordinates in the system, and therefore, establishes its coordinates as the origin of the coordinate system, in step 425. Thus, the user does need to inform the node 125k that it is the first node to establish coordinates, and is thus the origin.

Referring now to FIG. 3B and to step 430 in FIG. 4, in order to establish the x-axis of the coordinate system, the user 302 selects a second node 125l. The user 302 is free to select any convenient node. Upon being selected, the second node 125l broadcasts requests of other nodes to respond with their coordinates, in step 420. Because node 125l is the second node selected, only the first node 125k will respond with known coordinates. After a pre-determined period of time, the second node 125l will determine that it is the second node to establish coordinates. Referring to step 435, the coordinates of the second node 126l are established as (D_{KL}, O, O), where D_{KL} is the distance between the first node 125k and the second node 125l. Moreover, these coordinates effectively establish the x-axis.

The distance between the first node 125k and second node 125l is automatically determined by either or both the first node 125k or second node 125l. The technique for measuring the distance is not critical. In one embodiment, one of the nodes (e.g., 125k) sends out an RF and an ultrasound signal, which the other node (e.g., 125l) receives and calculates the distance based on the difference in time in receiving the signals. Each node (e.g., 125k and 125l) records the distance to the other node. Furthermore, each node 125k and 125l stores an accuracy parameter, which describes an expected accuracy of a node's coordinates. Determination of the accuracy parameter will be discussed in more detail herein below.

Referring now to FIG. 3C and to step 440 of FIG. 4, in order to establish the y-axis of the coordinate system, the user 302 selects a third node 125m. The user is free to select any convenient node. It is not required that the third node 125m is located on the y-axis, and typically the third node 125m will not be physically on the y-axis. However, it is preferred that the third does not form a straight line with the first node 125k and second node 125l. Upon being selected, the third node 125m broadcasts requests of other nodes to respond with their coordinates, as depicted in step 420 of FIG. 4. Because node 125m is the third node selected, only the first and second nodes 125k and 125l will respond with their known coordinates. After a predetermined period of time, the third node 125m will determine that it is the third node to establish coordinates. Referring to step 445 of FIG. 4, the coordinates of the third node 125m is established based on the distances from the third node 125m to the first node 125k and second node 1251 and their known coordinates. Moreover, the y-axis is determined as discussed more fully below.

To determine its coordinates and the y-axis, the third node 125m may use triangulation to calculate the values X_{C} and Y_{C} depicted in FIG. 3C. The third node 125m has two possible coordinates, based on this information (X_{C}, +|Y_{C}|) or (X_{C}, −|Y_{C}|). The third node 125m arbitrarily sets its coordinates to one of these positions. For example, the coordinates (X_{C}, +|Y_{C}|) are arbitrarily selected. Thus, the y-axis and the third node's coordinates are established.

Referring to FIG. 3D and step 450 of FIG. 4, a fourth node 125n that is not in the same plane as the first, second, and third node (125k, 125l, 125m) is selected by the user 302 in order to establish a z-axis. The user 302 is free to select any convenient node, provided it is not in the same plane as the first three nodes 125k, 125l, and 125m. It is not required that the fourth node 125n be located on the z-axis, and typically the fourth node 125n will not be physically on the z-axis. Upon being selected, the fourth node 125n broadcasts requests of other nodes to respond with their coordinates, as shown in step 420 of FIG. 4. Because node 125n is the fourth node selected, only the first, second, and third nodes 125k, 125l, and 125m will respond with their known coordinates. After a pre-determined period of time, the fourth node 125n will determine that it is the fourth node to establish coordinates. In step 455, the coordinates of the fourth node 125n and the z-axis are established based on the distances from the fourth node 125n to the first, second, and third nodes (125k, 125l, 125m) and their known coordinates. The z-axis may be established via known triangulation techniques analogous to those shown for establishing the y-axis. The process 400 of establishing the coordinate system then ends.

In another embodiment, the coordinate system has only one-dimension. In this case, only the steps depicted in FIG. 3A-3B, and steps 410-435 of FIG. 4 are performed. In yet another embodiment, the coordinate system has only two-dimensions. In this case, only the steps depicted in FIG. 3A-3C and steps 410-445 of FIG. 4 are performed.

In accordance with another embodiment of the present invention, a pre-established coordinate system is propagated to additional nodes. The coordinate system may be established in the manner of the embodiment described in FIGS. 3A-3D and FIG. 4, although this is not required. For purposes of illustration the following embodiment has a two-dimensional coordinate system; however, the concept is applicable to one- and three-dimensions. To propagate the two-dimensional coordinate system to additional nodes, the new node determines which three nodes in the system are likely to be suitable for it to determine its coordinates. In embodiments with one- or three-dimensions, other than three nodes are selected.

The selection of suitable nodes may be based on factors such as an accuracy parameter that defines how accurately the coordinates for a given node are believed to be and the geometric configuration of the three nodes. For example, if three nodes come too close too forming a straight line, then one of them is discarded in favor of a node that is not aligned with the other two.

Once the new node has found three suitable nodes, it determines its coordinates based on the distance between it and the three selected nodes and knowledge of the coordinates of the three selected nodes. For example, based on the distance between the new node and two other nodes, the new node determines a pair of possible coordinates. One member of the pair is valid, although it will not be exact because of imprecision in measurements. The other member of the pair is an invalid position because it is an extraneous mathematical solution. The new node then determines at least one more pair of possible coordinates, based on measurements to two nodes, wherein at least one of these nodes is not from the nodes for the first measurement.

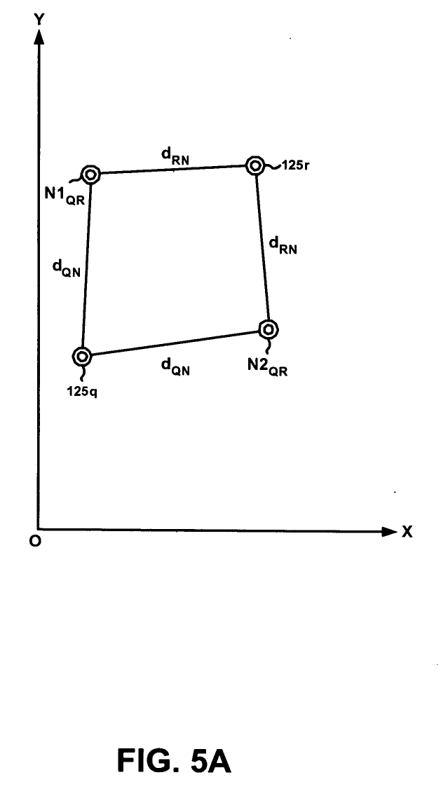

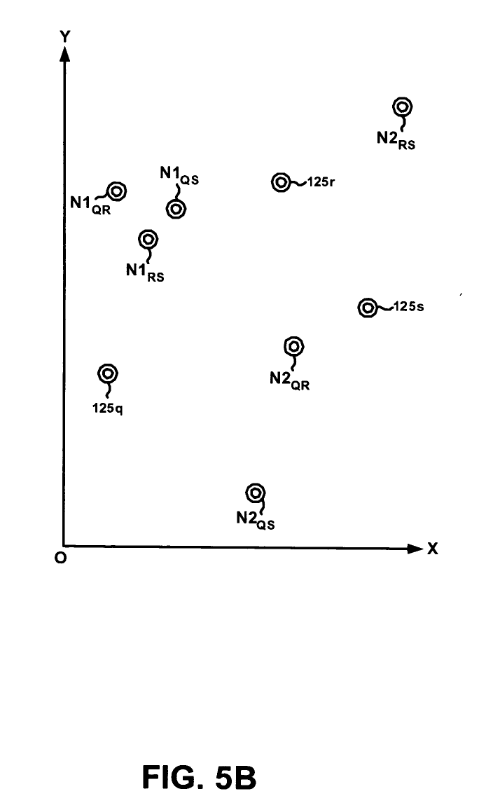

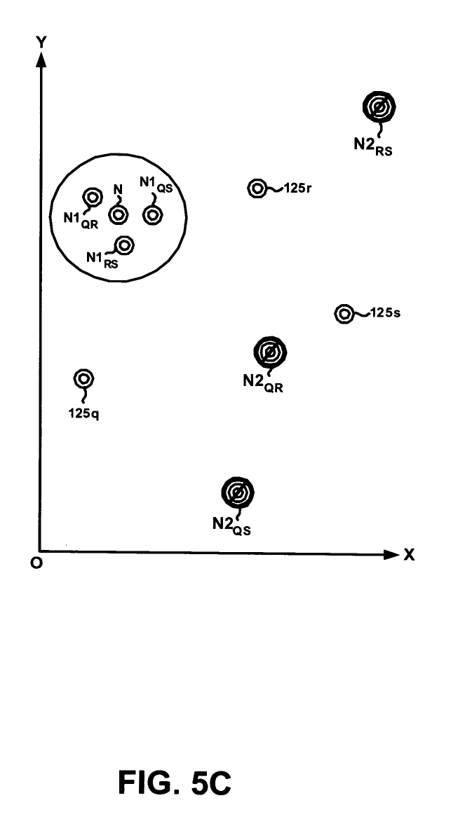

FIGS. 5A-5C are diagrams illustrating the propagation of a coordinate system for a network of nodes, in accordance with an embodiment of the present invention. This embodiment is for a two-dimensional coordinate system, but the concept may be applied to a one- or three-dimensional coordinate system.

Referring now to FIG. 5A, the new node (not depicted in FIG. 5A) first determines two possible coordinates NLQR and NLQR, based on distance measurements to two other nodes 125q and 125r. As shown in FIG. 5A, using just the information given by the two neighbor nodes 125q and 125r, the new node could be at the two possible locations N1_{QR} and N1_{QR}. The true location of the new node is close to one of the possible locations. Thus, only one of these two possible locations is valid. The “x” and “y” coordinates for locations N1_{QR} and N1_{QR} may be determined in accordance with the formulas in Equations 1-4, where d_{QN} is distance between the new node and node 125q, d_{RN} is distance between the new node and node 125r, d_{QR} is distance between the node 125q and node 125r, kx=(d_{QR}²+d_{QN}²−d_{RN}²)/(2*d_{QR}), and ky=(d_{QN}²−kx²)^{0.5}
N1x=Qx+(kx*(Rx−Qx)−ky*(Ry−Qy))/d_{QR}; Eq. 1:
N1y=Qy+(kx*(Ry−Qy)+ky*(Rx−Ry))/d_{QR}; Eq. 2:
N2x=Qx+(kx*(Rx−Qx)+ky*(Ry−Qy))/d_{QR}; Eq. 3.
N2y=Qy+(kx*(Ry−Qy)−ky*(Rx−Ry))/d_{QR}; Eq. 4:

The node then determines at least one more pair of possible coordinates based on measurements to another set of nodes, which it compares to the first pair of possible coordinates. A first pair of coordinates is labeled N1_{QR} and N1_{QR}, which were determined by measurements to nodes 125q and 125r as discussed above. A second pair of coordinates is labeled N1_{RS} and N2_{RS}, which were determined by measurements to nodes 125r and 125s in a manner similar to the method shown by Equations 1-4. A third pair are labeled N1_{QS} and N2_{QS}, which were determined by measurements to nodes 125q and 125s in a manner similar to the method shown by Equations 1-4. It will be understood that it is not required that the sets of nodes to which measurements are taken have a node in common.

In FIGS. 5B and 5C, all of the possible coordinates annotated “N2” are widely separated. Thus, these possible locations are deemed invalid. The valid coordinates, which are all annotated “N1”, are quite close to each other and are circled in FIG. 5C. Doing a distance comparison between all the possible locations, the invalid positions (N2_{QS}, N2_{RS} N2_{QR}) are discarded, as depicted in FIG. 5C. The new nodes final coordinates are depicted as “N” in FIG. 5C, and is based from the three valid coordinates (N1_{QS}, N1_{RS} N1_{QR}). The new node's final coordinates are based on the center of gravity of the valid sets of coordinates, in one embodiment. However, the final coordinates can be determined based on the valid coordinates in another fashion.

If the distance data between nodes were exact, finding the exact coordinates of a node would be relatively simple. For example, the exact coordinates could be determined by the intersection between three circles centered on three neighbor nodes with a radius equal to the distance between the new node and the respective neighbor nodes. Unfortunately, the distance values are not perfect. Thus, embodiments of the present invention employ a technique that allows for errors in measurement of the distance between nodes, while still accurately determining the actual coordinates of a node.

Moreover, many electronic devices do not have substantial computing power. Therefore, to save computation power, embodiments of the present invention do not to use any trigonometric function. The square root function is the only mathematic function used by some embodiments. For example, Equations 1-4 above use a square root (and square) function, along with mathematical operations of addition, subtraction, multiplication, and divide.

In order to implement various processes described herein, nodes store various information about other nodes in the system. In particular, a node may store the distance between itself and each neighbor node. For each neighbor node, an accuracy parameter is stored that defines how accurate the coordinates of the neighbor node is considered to be.

In accordance with one embodiment, the accuracy parameter is an integer number between 0 and 7. An accuracy parameter of “0” means the location of the neighbor node should not be used to help another node to initialize. This is the case for a mobile node or for an infrastructure node that does not know its location. An accuracy parameter of “1” means the node is one of the three initial nodes defining the coordinate system. They are the ones with the best accuracy. Other nodes compute their accuracy by adding “1,” to the worst accuracy of any node that was used to determine that node's coordinates. Thus, a node that uses nodes with accuracies of “1”, “1”, and “3” in order to determine its coordinates will have an accuracy of “4”. The upper limit is “7”. Thus, if a node initializes from a neighbor with an accuracy of “7,” its accuracy will be 7. The present invention is not limited to using this method of defining an accuracy parameter.

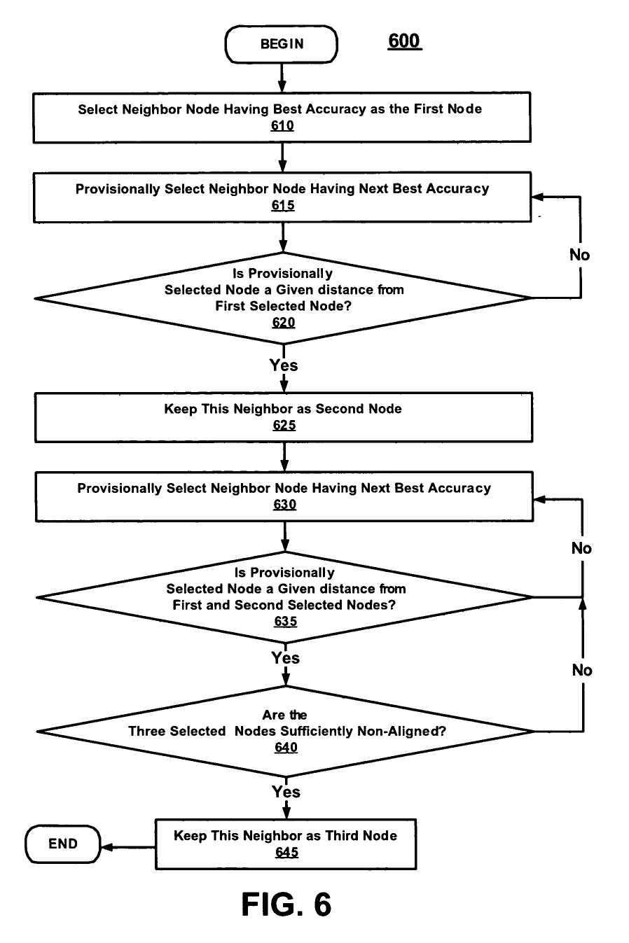

In accordance with an embodiment of the present invention, the nodes that are chosen to determine the coordinates of a new node is as follows. Steps of process 600 in FIG. 6 may be stored as instructions in computer readable memory and executed on a processor. When a node is to establish its coordinates, it will have a list of nodes that have already established coordinates, along with an accuracy parameter that defines how accurately the established coordinates are expected to be. This list of nodes serves as candidate nodes for helping the new node to establish it coordinates. In step 610, the first neighbor node selected from the candidate nodes is the one whose own coordinates have the best accuracy.

The second selected node with the next best accuracy is provisionally selected, provided that the node is at least a given distance away from the node selected in step 610. Thus, in step 615 the node having the best accuracy of all remaining nodes is provisionally selected.

In step 620, the distance between the first selected node and the provisionally selected node is tested to determine if it is at least a given distance. If not, step 615 is repeated to find the node with the next best accuracy. In one embodiment, the tested distance is a pre-determined value. In another embodiment, the tested distance is learned by the system, based on an analysis of how well the system is performing. In one embodiment, the tested distance is a pre-determined value of about two meters.

After a suitable second node is found, it is kept as the second node, in step 625.

The third chosen neighbor is the node with the next best accuracy, provided that the node is at least a given distance away from both the node selected in step 610 and the node kept in 625. Moreover, if the three selected nodes are deemed to be too aligned, then one of the nodes is discarded. Thus, in step 630, the node with the next best accuracy is provisionally selected.

In step 635, the distance between the provisionally selected node and both the first and second selected nodes are tested to determine if it is at least a given distance. If not, step 630 is repeated to find the node with the next best accuracy.

After the distance test in step 635 passes, an alignment test is made in step 640. In one embodiment, the alignment test is achieved by verifying that all three angles formed by the triangle defined by the first, second, and third selected nodes are greater than a given number of degrees. In one embodiment, this angle is a pre-determined value. In another embodiment, the angle is learned by the system, based on an analysis of how well the system is performing. In one embodiment, the angle is a pre-determined value of about 25 degrees.

If a node must be discarded in step 640, then step 630 is repeated until a suitable node is found, if possible. If a suitable third node is found, it is kept in step 645. The process 600 then ends. While not depicted in FIG. 6, it is possible that a third node (or second node) is not found to meet the established criteria of process 600. If a suitable third node is not found, the process 600 may discard the previously selected second node and return to step 615 (not depicted in FIG. 6) to find another second node. The process 600 then continues to seek a suitable second and third node. It is also possible that a suitable second node is not found. In this case, the previously selected first node may be discarded and the process 600 may return to step 610 (not depicted in FIG. 6) to select a new first node. The process 600 then continues to seek suitable second and third nodes. This technique of discarding previously selected nodes may continue until no more nodes are available to select, in which case the determination of coordinates for the new node if a given test may be aborted. It will be understood that process 600 is not limited to this method of resolving cases when suitable nodes are not found in a given pass through process 600. Alternatively, the process 600 may proceed with a node that violates one or more rules that were initially used in process 600. For example, the distance or angle tests in steps 620, 635, and/or 640 may be relaxed and various steps of process 600 repeated.

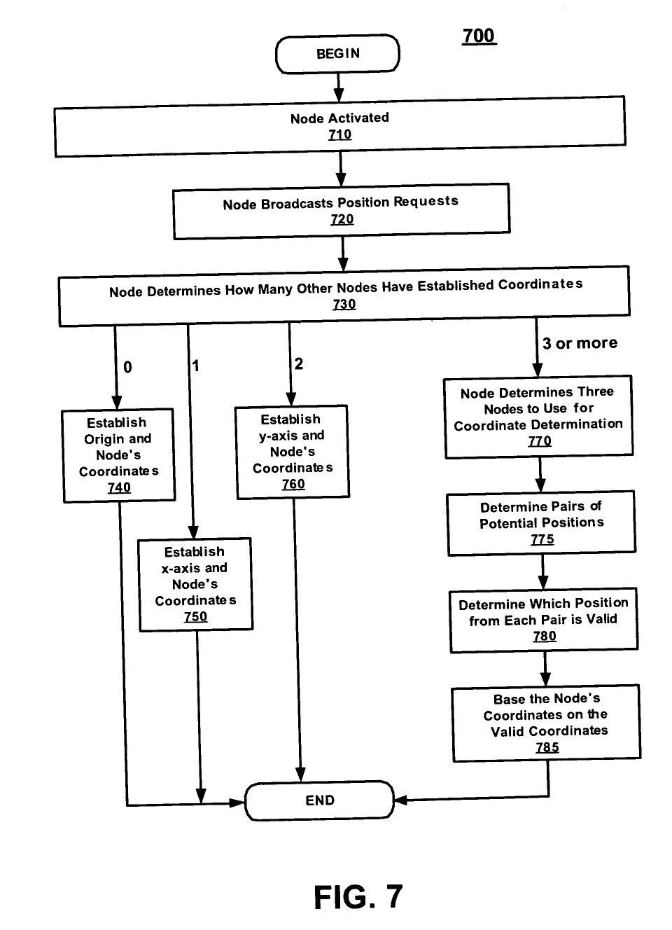

FIG. 7 is a flowchart illustrating steps of a process of propagating a coordinate system for a network of nodes, in accordance with an embodiment of the present invention. In step 710, the node is activated. The method of activation is not critical. It may be powering on the node, activating a select switch, etc. In one embodiment, the node is activated by user action. In another embodiment, the node is activated without user action, for example, by another device transmitting a signal to the node indicating that is has been activated.

In step 720, in response to the node being activated, the node broadcasts a request to other nodes for respective coordinate information of the other nodes. Based on the response to the request, the node takes one or more of steps 740-785.

The node establishes itself as an origin of the coordinate system if no nodes respond to the request with its coordinates, in step 740.

The node establishes a first axis of the coordinate system if one node responds to the request with its coordinates, in step 750. Step 750 may comprise accessing distance measurements between the node and the other node that responded.

The node establishes a second axis of the coordinate system if two nodes respond to the request with coordinates, in step 760. Step 760 may comprise accessing distance measurements between the node and the other nodes that responded.

The node determines coordinated for the node based on distance measurements to selected nodes having established coordinates if three nodes respond to the request with respective coordinates, in step 770.

If step 770 is taken, then the node takes several additional steps. Otherwise process 700 ends. Those additional steps are to determine pairs of potential coordinates based on distances between the node and nodes having established coordinates, in step 775. FIGS. 5A-5B and associated description herein detail one technique for determining pairs of potential coordinates.

The node selects one set of coordinates from each of the pairs of potential coordinates to form valid coordinates, in step 780. FIG. 5C and associated description herein detail one technique for selecting one set of coordinates out of each pair as being the valid set.

The node bases coordinates of the node on the valid coordinates, in step 785. Step 785 may comprise determining the center of gravity of the valid sets of coordinates, although other techniques may be used. This ends process 700.

While the present invention has been described in particular embodiments, it should be appreciated that the present invention should not be construed as limited by such embodiments, but rather construed according to the below claims.

What is claimed is:

1. A method of establishing a coordinate system for a network of nodes, comprising:
establishing an origin of said coordinate system by:
receiving an indication that a first node is selected; and
automatically determining that said first node is said origin of said coordinate system in response to said indication that said first node is selected; and
establishing a first axis for said coordinate system by:
receiving an indication that a second node is selected;
automatically determining said first axis based on a line between said first node and said second node in response to said indication that said second node is selected.

2. The method of claim 1, further comprising:
establishing a second axis for said coordinate system by:
receiving an indication that a third node is selected; and
automatically determining said second axis based on position of said third node with respect to said first and second nodes in response to said indication that said third node is selected.

3. The method of claim 2, further comprising:
establishing a third axis for said coordinate system by:
receiving an indication that a fourth node is selected; and
automatically determining said third axis based on said relative positions of said first, second, third, and fourth nodes in response to said indication that said fourth node is selected.

4. The method of claim 1, further comprising, in response to said indications that said first, second, and third nodes are selected, said first, second, and third nodes broadcasting requests for other nodes to respond with their respective coordinates.

5. The method of claim 4, further comprising determining that said origin, said first axis, and said second axis are to be determined based on responses, if any, from said requests.

6. The method of claim 1, wherein said automatically determining that said first node is said origin of said coordinate system further comprises:
said first node broadcasting a first request for other nodes to respond with respective coordinates for said other nodes; and
said first node establishing itself as said origin of said coordinate system in response to said first node determining that no other node in said network responds to said first request.

7. The method of claim 6, wherein said automatically determining said first axis based on the line between said first node and said second node comprises
said second node broadcasting a second request for other nodes to respond with respective coordinates for said other nodes; and
said second node determining that only said first node responds to said second request, wherein said second node determines that said second node is to establish said first axis.

8. A method of propagating an established coordinate system, comprising:
determining a first pair of possible coordinates for a new node, based on first distance measurements between said new node and first nodes having first respective node coordinates;
determining a second pair of possible coordinates for said new node, based on second distance measurements between said new node and second nodes having second respective node coordinates, wherein said second distance measurements comprise at least one measurement to a node not in said first nodes; and
determining defined coordinates for said new node by determining one set of coordinates from each of said first and said second pair of possible coordinates as valid coordinates and basing said defined coordinates on said determined valid coordinates.

9. The method of claim 8, further comprising determining that nodes to use for distance measurements are said first nodes and said second nodes.

10. The method of claim 8, further comprising:
determining a third pair of possible coordinates for said new node, based on third distance measurements between said new node and third nodes having third respective node coordinates, and wherein:
said determining defined coordinates for said new node by determining one set of coordinates from each of said first and said second pair of possible coordinates as valid coordinates comprises determining one set of coordinates from each of said first, said second, and said third pair of possible coordinates.

11. The method of claim 8, wherein said basing said defined coordinates on said valid coordinates comprises determining a center of gravity of said valid coordinates.

12. The method of claim 8, wherein said established coordinate system has two-dimensions and said determining the first pair of possible coordinates for the new node comprises determining said first pair of possible coordinates based on distance measurements to two nodes in said first nodes.

13. The method of claim 8, wherein said established coordinate system has three-dimensions and said determining the first pair of possible coordinates for the new node comprises determining said first pair of possible coordinates based on distance measurements to three nodes in said first nodes.

14. The method of claim 8, further comprising selecting said first nodes and second nodes from a group of nodes having established coordinates based on how accurate said established coordinates are expected to be.

15. The method of claim 14, wherein said selecting said first nodes and second nodes is further based on a distance between nodes in said first nodes.

16. The method of claim 14, wherein said new node selecting said first nodes and second nodes is further based on alignment of nodes in said first nodes and second nodes.

17. A method of establishing coordinates for nodes in a network, comprising:
in response to a first node being selected, said first node broadcasting a request to other nodes for respective coordinate information of said other nodes; and
said first node establishing itself as an origin of said coordinate system if none of said other nodes respond to said request with coordinates for said other nodes;
said first node establishing a first axis of said coordinate system if one node of said other nodes responds to said request with coordinates for said one node;
said first node establishing a second axis of said coordinate system if two nodes of said other nodes respond to said request with respective coordinates for said two nodes; and
said first node determining coordinates for said first node based on distance measurements to selected nodes of said other nodes having established coordinates if three nodes of said other nodes respond to said request with respective coordinates for said three nodes.

18. The method of claim 17, wherein said first node determining coordinates for said first node comprises:
determining pairs of potential coordinates based on distances between said first node and said nodes having established coordinates;
selecting one set of coordinates from each of said pairs of potential coordinates to form valid coordinates; and
basing coordinates of said first node on said valid coordinates.

19. The method of claim 17, wherein said first node determines said selected nodes having established coordinates from a group of nodes having established coordinates based on how accurately said established coordinates of said group of nodes are expected to be.

20. The method of claim 19, wherein first new node determining said selected nodes is further based on a distance between nodes identified as candidate nodes in said group of nodes.

21. The method of claim 20, further comprising rejecting one of said candidate nodes if said distance is less than a pre-determined value.

22. The method of claim 20, further comprising rejecting one of said candidate nodes if said distance is less than a value learned by said network.

23. The method of claim 20, wherein first new node determining said selected nodes is further based on an angle formed between said candidate nodes.

24. The method of claim 23, further comprising rejecting one of said candidate nodes if said angle is greater than a value learned by said network.

25. A method of propagating an established coordinate system, comprising:
a new node determining a first pair of possible locations for said new node, based on a first at least one distance measurement to at least one node in a first group of nodes having respective node locations;
said new node determining a second pair of possible locations for said new node, based on a second at least one distance measurement to at least one node in a second group of nodes having respective node locations, wherein said second distance measurements comprise at least one measurement to a node not in said first group of nodes; and
said new node determining a defined location for said new node by determining a location from each of said first and second pair as a valid location and basing said defined location on said determined valid locations.

26. The method of claim 25, wherein said coordinate system has one-dimension and said determining a first pair of possible locations for said new node comprises said new node determining said first pair of possible locations for said new node, based on distance measurements to one node in said first group of nodes.

27. The method of claim 25, wherein said coordinate system has two-dimensions and said determining a first pair of possible locations for said new node comprises determining said first pair of possible locations based on distance measurements to two nodes in said first group of nodes.

28. The method of claim 25, wherein said coordinate system has three-dimensions and said determining a first pair of possible locations for said new node comprises determining said first pair of possible locations based on distance measurements to three nodes in said first group of nodes.

29. A location aware device, comprising:
a selection unit configured to receive an indication that the device is selected;
a communication unit configured to communicate with other devices; and
a processing unit coupled to said communication unit and said selection unit, said processing unit configured to:
in response to said indication that the device is selected, control the communication unit to determine how many other devices have already been selected;
establish said device as an origin of said coordinate system if no other devices respond with an indication that the other devices have been selected;
establish a first axis of said coordinate system if one other device indicates that the one other device has been selected; and
establish a second axis of said coordinate system if two other devices indicate that said two other devices have been selected.

30. The device of claim 29, wherein said processing unit is further configured to determine coordinates for said device based on distance measurements to other devices having established coordinates if three other devices indicate that said three other devices have been selected.

31. The device of claim 29, wherein said processing unit is further configured to:
determine a first pair of possible coordinates for said device, based on first distance measurements between said device and first nodes having first respective node coordinates;
determine a second pair of possible coordinates for said device, based on second distance measurements between said device and second nodes having second respective node coordinates, wherein said second distance measurements comprise at least one measurement to a node not in said first nodes; and
determine defined coordinates for said device by determining one set of coordinates from each of said first and said second pair of possible coordinates as valid coordinates and basing said defined coordinates on said determined valid coordinates.

32. The device of claim 31, wherein said processing unit is further configured to determine said first nodes and second nodes from a group of nodes having established coordinates based on how accurate said established coordinates are expected to be.

33. The device of claim 32, wherein said processing unit is further configured to determine said first nodes and second nodes based on a distance between nodes in said first nodes.

34. The device of claim 33, wherein said processing unit is further configured to determine said first nodes and second nodes based on alignment of nodes in said first nodes and second nodes.

35. The device of claim 29, wherein said selection unit comprises a power on switch for the device.

36. The device of claim 29, wherein said selection unit comprises a switch that has a dedicated purpose of selecting the device.

37. The device of claim 29, wherein said communication unit comprises a radio frequency transceiver and an ultrasound transceiver.
